(19) United States
(12) Patent Application Publication
(10) Pub. No.: US 2014/0263879 A1
(43) Pub. Date: Sep. 18, 2014

(54) COMPLIANT BEARING SYSTEM WITH A RIGID SUPPORT STRUCTURE

(71) Applicant: GILSON, INC., Middleton, WI (US)

(72) Inventors: David Barton, Madison, WI (US); Timothy Edward Higgins, Madison, WI (US)

(73) Assignee: Gilson, Inc., Middleton, WI (US)

(21) Appl. No.: 13/827,317

(22) Filed: Mar. 14, 2013

(51) Int. Cl. F16M 11/04

(52) U.S. Cl. CPC F16M 11/048
USPC 248/121

(57) ABSTRACT

A translational support system is provided that includes a first wall and a second wall, a first support bracket mounted to the first wall, a second support bracket mounted to the second wall, a bearing rod, a base, a bearing carriage, and a rigid support. The bearing rod is mounted between the brackets. The base is mounted between the walls and includes a base plate having a first side and a second side and a slot formed through the base plate. The bearing carriage is positioned on the first side of the base plate and mounted to translate along the bearing rod in a plane parallel to the first side. The bearing carriage includes a leg mounted to a device support structure through the slot. The rigid support is mounted to the second side of the base plate. The rigid support supports the device support structure above the base plate.

### BACKGROUND

In pharmaceutical, genomic and proteomic research and drug development laboratories, as well as similar applications, automated liquid handlers are used for handling laboratory samples in a variety of laboratory procedures to prepare the samples for analysis. For example, liquid handlers are used for biotechnological and pharmaceutical liquid assay procedures, sample preparation, compound distribution, microarray manufacturing, etc. For illustration, automated liquid handlers are disclosed in U.S. Pat. Nos. 4,422,151; 5,988,236; 7,055,402; 7,288,228; 7,669,489; 7,874,324 assigned to the assignee of the present application and incorporated herein by reference. In general, a liquid handler has a work bed that supports one or more sample holding receptacles, with one or more pipetting heads mounted to move over the work bed and to aspirate/dispense liquid from/into the sample receptacles.

Liquid chromatography is one example of an application in which automated liquid handlers are used. Liquid chromatography is useful in characterizing a sample through separation of its components by flow through a chromatographic column, followed by detection of the separated components with a flow-through detector. Some liquid chromatography systems include an automated liquid handler to load samples using the one or more pipetting heads. A metal needle may be attached to the one or more pipetting heads to facilitate extraction of the sample from the container and injection of the sample into an injection port. The one or more pipetting heads are generally mounted to an arm that is mounted to a linear bearing system that may be movable in X, Y, and/or Z directions as understood by a person of skill in the art using one or more actuators and controllers. As understood by a person of skill in the art, disposable tips may be used on the one or more pipetting heads.

Automated liquid handlers are also used to perform a solid-phase extraction process that separates compounds in a mixture to concentrate and purify samples from the mixture for analysis. In solid-phase extraction, a conditioning liquid flows through a stationary phase to separate desired components from undesired components. One or more washing steps may then be used to eliminate the undesired components. Finally, the desired components may be transferred into a collection receptacle such as a tube or well for further analysis.

Traditional linear bearing designs for automated liquid handling systems incorporate a rigid rail support structure that ensures that forces perpendicular to the direction of motion of the work bed result in only minimal displacement (flexing) of the bearing system. This rigidity is required to minimize positional errors that result from elastic deformation of the components that comprise the bearing support structure. While a linear bearing system can be designed with very high stiffness, the ability to resist large transverse loads necessitates larger size and thicker wall sections in bearing support components, often with post-processing to increase material strength such as work hardening or heat treating the material. The cost of a bearing system increases quickly when its support structure is oversized and strengthened as described, and since there are often at least three bearing systems in an automated liquid handling system to support movement in three directions, this additional bearing system cost is not trivial with respect to the rest of the assemblies that form the automated liquid handling system.

A secondary problem with designing a stiff bearing system is that the system usually experiences an approximately linear deflection under load, until the onset of mechanical failure. This is undesirable because it introduces positional error that depends on the transverse load. As a result, some automated liquid handling systems employ sophisticated calibration strategies to account for the positional error associated with frequently-occurring transverse loads.

### SUMMARY

In an illustrative embodiment, a translational support system is provided. The translational support system includes, but is not limited to, a bearing rod, a bearing carriage, a base plate, and a rigid support. The bearing rod is mounted between a first support bracket and a second support bracket. The first support bracket and the second support bracket are mounted between a plurality of walls. The bearing carriage is mounted to translate along the bearing rod. The base plate has a first side and a second side. The bearing carriage is mounted to the first side. The rigid support is mounted to the first side of the base plate. The rigid support is positioned to support a device above the first side of the base plate.

In another illustrative embodiment, a work bed is provided. The work bed includes, but is not limited to, a translating plate, a base, a bearing rod, a bearing carriage, and a rigid support. The base includes, but is not limited to, a base plate, a plurality of walls, and a slot formed through the base plate. The base plate has a first side and a second side. The plurality of walls extends from the base plate in a first direction. The bearing rod is mounted between a first support bracket and a second support bracket. The first support bracket and the second support bracket are mounted between the plurality of walls. The bearing carriage is mounted to translate along the bearing rod in a plane parallel to the first side of the base plate. The bearing carriage includes, but is not limited to, a leg mounted to the translating plate through the slot. The rigid support is mounted to the second side of the base plate. The rigid support is positioned to support the translating plate above the second side of the base plate.

In yet another illustrative embodiment, a work bed is provided. The work bed includes, but is not limited to, a translating plate, a base, a bearing rod, a bearing carriage, and a rigid support. The base includes, but is not limited to, a base plate having a first side and a second side. The base includes a slot formed through the base plate. The bearing rod is mounted between a first support bracket and a second support bracket. The first support bracket and the second support bracket are mounted to the first side of the base. The bearing carriage is mounted to translate along the bearing rod in a plane parallel to the first side of the base plate. The bearing carriage includes a leg mounted to the translating plate through the slot. The rigid support is mounted to the second side of the base plate. The rigid support is positioned to support the translating plate above the second side of the base plate.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts a right, perspective view of a liquid handling system in accordance with an illustrative embodiment.

FIG. 2 depicts a front view of the liquid handling system of FIG. 1.

FIG. 3 depicts a right side view of the liquid handling system of FIG. 1 with protective covers removed.

FIG. 4 depicts a bottom, right perspective view of the liquid handling system of FIG. 1.

FIG. 5 depicts a cross-sectional view through the bearing system of the liquid handling system of FIG. 1.

FIG. 6 depicts an enlargement of a portion of the cross-sectional view of FIG. 5.

FIG. 7 depicts a bottom view of the liquid handling system of FIG. 1.

FIG. 8 depicts a right side cross-sectional view of an enlarged portion of the liquid handling system of FIG. 1.

FIG. 9 depicts a top view of the liquid handling system of FIG. 1 with a protective cover removed.

FIG. 10 depicts a top, perspective view of a base and translating plate of the liquid handling system of FIG. 1.

FIG. 11 depicts a top, perspective view of the base of the liquid handling system of FIG. 1.

FIG. 12 depicts a block diagram of a controller of liquid handling system of FIG. 1 in accordance with an illustrative embodiment.

### DETAILED DESCRIPTION

With reference to FIGS. 1-4, views of a liquid handling system 100 are shown in accordance with an illustrative embodiment. With reference to FIG. 1, a right perspective view of liquid handling system 100 is shown. With reference to FIG. 2, a front view of liquid handling system 100 is shown. With reference to FIG. 3, a right side view of liquid handling system 100 is shown. With reference to FIG. 4, a bottom, right perspective view of liquid handling system 100 is shown. Liquid handling system 100 includes any type of device that performs aspiration and/or dispensation of liquid to support analysis and preparation of a sample including high-pressure liquid chromatography systems, solid phase extraction systems, etc.

In the illustrative embodiment, liquid handling system 100 may include a cover 102, a base 104, a work bed 106, a drive system 108, a liquid handling head 110, and a plurality of pipetting heads 112. The components of liquid handling system 100 may be formed of a variety of materials including one or more metals or plastics having a sufficient strength and rigidity for the described application. Liquid handling system 100 may include additional, fewer, or different components. For example, cover 102 is optional and may be completely or partially removeable from base 104.

Cover 102 is mounted to base 104 to protect the components of liquid handling system 100. As used in this disclosure, the term “mount” includes join, unite, connect, associate, insert, hang, hold, affix, attach, fasten, bind, paste, secure, bolt, screw, rivet, solder, weld, glue, abut, mold, thermoform, couple, nail, etc. The phrases “mounted on” and “mounted to” include any interior or exterior portion of the support member referenced. These phrases also encompass direct mounting (in which the referenced elements are in direct contact) and indirect mounting (in which the referenced elements are not in direct contact and are mounted together via intermediate elements). Additionally, some components may be mounted to each other by molding or thermoforming such that the components form a single integral component.

Cover 102 may include a first cover portion 114, a second cover portion 116, a first hinge 118, and a second hinge 200 (shown with reference to FIG. 2). First hinge 118 and second hinge 200 mount first cover portion 114 to second cover portion 116 so that first cover portion 114 can be rotated upward to provide access to the components of liquid handling system 100 while second cover portion 116 remains mounted to base 104. Each of first cover portion 114 and second cover portion 116 include a plurality of walls configured to enclose the components of liquid handling system 100.

Base 104 may include a base plate 118, a front wall 120, a right side wall 122, a left side wall 202 (shown with reference to FIG. 2), and a back wall 300 (shown with reference to FIG. 3). Use of directional terms, such as top, bottom, right, left, front, back, etc. are merely intended to facilitate reference to the various surfaces that form components of liquid handling system 100 and are not intended to be limiting in any manner. The walls 120, 122, 202, 300 may have a variety of shapes that extend from base plate 118. The walls 120, 122, 202, 300 and base plate 118 may be molded as a single piece. Though feet may be mounted to the walls 120, 122, 202, 300, the walls 120, 122, 202, 300 and base plate 118 generally provide a support structure for liquid handling system 100.

Base plate 118 includes a top surface 124, a bottom surface 400 (shown with reference to FIG. 6), a first rigid support 126, a second rigid support 128, a third rigid support 600 (shown with reference to FIG. 6), a fourth rigid support 1100 (shown with reference to FIG. 11), a first elongated slot 130, and a second elongated slot 132. First rigid support 126, second rigid support 128, third rigid support 600, and fourth rigid support 1000 protrude from top surface 124 to support work bed 106 above top surface 124 of base plate 118.

First elongated slot 130 and second elongated slot 132 are formed through the base plate to allow insertion of a first leg 602 (shown with reference to FIG. 6) and a second leg 604 (shown with reference to FIG. 6), respectively, of a bearing carriage 402 (shown with reference to FIG. 4) and a translating plate 606 (shown with reference to FIG. 6). First leg 602 and second leg 604 may mount a translating plate 606 (shown with reference to FIG. 6) to bearing carriage 402. In the illustrative embodiment, first rigid support 126, second rigid support 128, third rigid support 600, fourth rigid support 1000, first elongated slot 130, and second elongated slot 132 are elongated in approximately parallel directions to each other and to right side wall 122 and left side wall 202. First rigid support 126, second rigid support 128, third rigid support 600, fourth rigid support 1000, first elongated slot 130, and second elongated slot 132 are further elongated in the direction of translation of translating plate 606.

Work bed 106 may include translating plate 606 and a rack plate 134. Rack plate 134 is mounted on translating plate 606. In alternative embodiments, work bed 106 may include a single plate. Work bed 106 may be fixedly or removably mounted on first leg 602 and second leg 604. Work bed 106 may have a variety of shapes (circular, elliptical, polygonal, etc.) and sizes based on the processing performed by liquid handling system 100. Work bed 106 further may be formed of a variety of materials based on the processing performed by liquid handling system 100. For example, a metal or plastic may be used to form work bed 106. Rack plate 134 may be fixedly or removably mounted on translating plate 606.

With reference to FIG. 9, rack plate 134 may include a plurality of ridges 918 that extend up from rack plate 134 away from translating plate 606. The plurality of ridges 918 provide a layout for racks though other sized and shaped racks may be mounted on rack plate 134 in other locations. Rack plate 134 includes a first cavity 900, a second cavity 902, a third cavity 904, a fourth cavity 906, a fifth cavity 908, a sixth cavity 910, a seventh cavity 912, an eighth cavity 914, and a ninth cavity 916 formed as a 3×3 grid by the plurality of ridges 918. Merely for illustration, a first rack 136 is shown mounted in fourth cavity 906, and a second rack 138 is shown mounted in eighth cavity 914 of rack plate 134.

First rack 136 and second rack 138 are configured to hold one or more receptacles. The one or more receptacles are configured to hold a sample for analysis and/or a liquid used for analysis of the sample and/or a liquid used for preparation of the sample. For illustration, the one or more receptacles may be vials, test tubes, bottles, etc. of various shapes and sizes. The sample may be in liquid or solid form. Pumps, diluters, valves, heaters, chillers, analysis components, microplates, etc. further may be mounted on rack plate 134.

Drive system 108 may include a first side wall 204 (shown with reference to FIG. 2), a second side wall 206 (shown with reference to FIG. 2), a device support structure 140, a lead screw 142, a lead screw interface 144, a first bracket 208 (shown with reference to FIG. 2), a second bracket 210 (shown with reference to FIG. 2), a first bearing rail 146, and a second bearing rail 212 (shown with reference to FIG. 2). First side wall 204 and second side wall 206 are mounted to base 104 to extend up from base plate 118. First bracket 208 is mounted to first side wall 204. Second bracket 210 is mounted to second side wall 206. Lead screw 142 is mounted between first support bracket 204 and second support bracket 206. Lead screw interface 144 is mounted to device support structure 140, and lead screw 142 is mounted to lead screw interface 144. Device support structure 140 translates along lead screw 142. Device support structure 140 further may be mounted to first bearing rail 146 and second bearing rail 212. Device support structure 140 also translates along first bearing rail 146 and second bearing rail 212.

A second base (not shown) may be mounted between first side wall 204 and second side wall 206. The second base may include a second base plate. Similar to base plate 118, the second base plate includes a top surface, a bottom surface, a rigid support, and an elongated slot. The rigid support protrudes from the top surface of the second base plate to support device support structure 140 above the top surface of the second base plate. The second base plate is positioned above lead screw 142 and lead screw interface 144. The elongated slot is formed through the second base plate to allow insertion of a first leg that is mounted to lead screw interface 144.

In an illustrative embodiment, an actuator is mounted to control movement of device support structure 140 along lead screw 142. Illustrative actuators include an electric motor, a servo, stepper, or piezo motor, a pneumatic actuator, a gas motor, etc. Drive system 108 may include one or more actuators operably coupled to control movement of device support structure 140 to position the plurality of pipetting heads 112 over a receptacle mounted on rack plate 134. Drive system 108 may provide movement of device support structure 140 in one-dimension, two-dimensions, or three-dimensions relative to rack plate 134. In the illustrative embodiment of FIGS. 1-4, drive system 108 provides movement of the plurality of pipetting heads 112 in two-dimensions (y-z) relative to rack plate 134. Of course, drive system 108 can be figured to provide movement in one-dimension or three-dimensions in alternative embodiments.

In another illustrative embodiment, a plurality of drive systems 1202 (shown with reference to FIG. 12) control movement of device support structure 140 and of rack plate 134. For example, the plurality of drive systems 1202 may include drive system 108 and a second drive system (not shown). In this alternative, drive system 108 controls movement of device support structure 140 in one-dimension (y) or two-dimensions (y-z) relative to rack plate 134, while the second drive system controls movement of rack plate 134 in one-dimension (x) relative to base 104. Liquid handling head 110 provides aspiration/dispensation of sample or other liquids through the plurality of pipetting heads 112 and into or out of a receptacle mounted on rack plate 134 when liquid handling head 110 is appropriately positioned over the receptacle.

With reference to FIGS. 4-8, a bearing system 404 is shown in accordance with an illustrative embodiment. Bearing system 404 may include bearing carriage 402, a first support bracket 406, a second support bracket 408, a first bearing rod 608 (shown with reference to FIG. 6), a first bearing 609 (shown with reference to FIG. 6), a second bearing rod 610 (shown with reference to FIG. 6), a second bearing 611 (shown with reference to FIG. 6), and a lead screw 612 (shown with reference to FIG. 6). First support bracket 406 and second support bracket 408 mount to bottom surface 400 of base plate 118.

In an illustrative embodiment, bearing system 404 is a linear slide designed to provide free motion of translating plate 606 in the x-dimension as defined by first elongated slot 130 and second elongated slot 132. Thus, first bearing rod 608 fits within first bearing 609 allowing first bearing 609 to slide along first bearing rod 608 in the x-dimension, and second bearing rod 610 fits within second bearing 611 allowing second bearing 611 to slide along second bearing rod 610 in the x-dimension.

Bearing carriage 402 may include first leg 602 and second leg 604, which extend up from a body 614 of bearing carriage 402 so that first leg 602 and second leg 604 can extend through first elongated slot 130 and second elongated slot 132, respectively, while allowing free movement of bearing carriage 402 in the x-dimension.

Translating plate 606 mounts to first leg 602 and second leg 604 using one or more fasteners. For example, with reference to FIG. 10, a screw, rivet, nail, etc. may be inserted in each of a first aperture 1000, a second aperture 1002, a third aperture 1004, and a fourth aperture 1006 to mount translating plate 606 to first leg 602 and second leg 604.

First bearing rod 608, second bearing rod 610, and lead screw 612 are mounted between first support bracket 406 and second support bracket 408 using any of a variety of fasteners including a frictional fit or molding as understood by a person of skill in the art. The use of the term bracket is not intended to be limiting as a variety of fasteners may be used to mount first bearing rod 608, second bearing rod 610, and lead screw 612 to base 104. First bearing 609 and second bearing 611 are mounted to bearing carriage 402.

Of course, there may be a greater or a fewer number of elongated slots, bearing rods, bearings, and fasteners used in alternative embodiments. For example, two bearings may be mounted to each of first bearing rod 608 and second bearing rod 610 instead of one.

There are many different types of linear motion bearings as understood by a person of skill in the art. A plain bearing is the simplest type of bearing and includes just a bearing surface and no rolling elements. Therefore, first bearing rod 608 slides over a bearing surface within first bearing 609, and second bearing rod 610 slides over a bearing surface within second bearing 611. First bearing 609 and second bearing 611 may be filled with a lubricant or rolling elements to facilitate sliding along first bearing rod 608 and second bearing rod 610, respectively. Additionally, first bearing rod 608 and second bearing rod 610 may be threaded as understood by a person of skill in the art. First bearing rod 608 and second bearing rod 610 also may have a non-circular cross section.

A pad 616 may be mounted on third rigid support 600. Pad 616 may be formed of a low friction material. Additional pads may be correspondingly mounted on first rigid support 126, second rigid support 128, and fourth rigid support 1100. Pad 616 and/or the rigid supports 126, 128, 600, 1100 have a rigidity that is sufficient to support a maximum design load applied to translating plate 606 without flexing. In contrast, first bearing rod 608 and second bearing rod 610 may be selected to flex when a nominal design load is applied to the translating plate 606.

With reference to FIG. 11, a top, perspective view of top surface 124 of base 104 is shown in accordance with an illustrative embodiment. First rigid support 126, second rigid support 128, third rigid support 600, and fourth rigid support 1100 are distributed across top surface 124. First rigid support 126 and second rigid support 128 are positioned near outside edges of translating plate 606 when translating plate 606 is positioned for use by liquid handling head 110. A length of first rigid support 126 and second rigid support 128 in the x-dimension is approximately equal to a length of translating plate 606 in the x-dimension. Third rigid support 600 is positioned between first elongated slot 130 and second elongated slot 132. Fourth rigid support 1100 is positioned between first elongated slot 130 and first rigid support 126.

Other arrangements of the rigid supports 126, 128, 600, 1100 are possible with varying lengths and widths for the rigid supports 126, 128, 600, 1100. For example, the numbering and area of support provided by the rigid supports 126, 128, 600, 1100 depends on the rigidity of translating plate 606 and the transverse load applied to translating plate 606 by racks mounted on rack plate 134. First rigid support 126 and second rigid support 128 are elongated to prevent translating plate 606 from tipping or tilting under the weight of heavy receptacles or equipment that may be installed when translating plate 606 is moved to the forward most position. Fourth rigid support 1100 and third rigid support 600 are shortened because the transverse loading applied by plurality of pipetting heads 112 can only be applied in the region directly over these shortened supports.

A gap may be designed between pad 616 and translating plate 606 when no load is applied to translating plate 606. The gap may be designed to ensure clearance while accommodating manufacturing tolerances that result in variations in the spacing between pad 616 and translating plate 606. The gap reduces the likelihood of wear on the rigid supports 126, 128, 600, 1100.

First rigid support 126, second rigid support 128, third rigid support 600, and fourth rigid support 1100 deflect transverse loads applied to translating plate 606 rather than applying the loads to bearing system 404, which allows a low cost design for bearing system 404. Bearing system 404 allows a small, controlled amount of flexing under the influence of transverse loads before the load is transmitted directly to first rigid support 126, second rigid support 128, third rigid support 600, and fourth rigid support 1100. The rigid supports 126, 128, 600, 1100 are decoupled from bearing system 404, and may be engaged through a wear-resistant interface such as that provided by pad 616. Once bearing system 404 accepts its maximum allowable deflection under load, translating plate 606 engages rigid supports 126, 128, 600, 1100, and further deflection of bearing system 404 is prevented.

The benefit of this solution is that bearing system 404 can be made from components that are low-cost, and that would not be capable of supporting the required amount of transverse loading if they did not have rigid supports 126, 128, 600, 1100. First bearing rod 608 and second bearing rod 610 can be undersized, and the remaining components of bearing system 404 can be constructed with low-cost components such as sheet metal parts and injection molded or thermoformed plastic designs. When these cost savings are applied to all of the bearing systems in a typical instrument, such as liquid handling system 100, a large amount of money can be saved.

The positional error generated as a function of the applied transverse load increases approximately linearly until rigid supports 126, 128, 600, 1100 are engaged, and further deflection is prevented by the support. As a result, the positional error no longer increases with transverse load, which benefits instrument calibration, and also affords a repeatable “reference displacement” that can be contacted to accurately apply forces and compressions to components that are being positioned by bearing system 404.

In the illustrative embodiments, the device being translated has been mounted to the bearing carriage through slots in a base plate. However, in alternative embodiments elongated slots are not needed. For example, the bearing rod can be mounted between a first support bracket and a second support bracket, which may be mounted between a plurality of walls. The bearing carriage is mounted to translate along the bearing rod. The translating plate has a first side and a second side. The first side is mounted to the bearing carriage. The rigid support is mounted to the second side of the translating plate. The rigid support is positioned to support a device above the second side of the translating plate.

With reference to FIG. 12, a controller 1200 of liquid handling system 100 is shown in accordance with an illustrative embodiment. Controller 1200 controls the operation of the components of liquid handling system 100. For example, controller 1200 may be operably coupled to drive system 1202 of either device support structure 140 or work bed 106. Controller 1200 may also control liquid pumping including aspirating and dispensing to/from liquid handling head 110. With reference to FIG. 7, one or more of the components of controller 1200 may be mounted on a printed circuit board 700 mounted on bottom surface 400 of base plate 118.

Controller 1200 may include an input interface 1202, an output interface 1204, a communication interface 1206, a computer-readable medium 1208, a processor 1210, and a control application 1212. Different, fewer, and additional components may be incorporated into controller 1200.

Input interface 1202 provides an interface for receiving information from the user for processing by controller 1200 as understood by those skilled in the art. Though not shown, input interface 1202 may further provide an interface for receiving information from drive system 1202 and/or liquid handling head 110 for processing by controller 1200 as known to those skilled in the art. Input interface 1202 may interface with various input technologies including, but not limited to, a display 1214, a keyboard 1216, a mouse 1218, a touch screen, a track ball, a keypad, etc. to allow the user to enter information into controller 1200 or to make selections presented in a user interface displayed on display 1214. Display 1214 may be a thin film transistor display, a light emitting diode display, a liquid crystal display, or any of a variety of different displays known to those skilled in the art. Controller 1200 may have one or more input interfaces that use the same or a different input interface technology.

Output interface 1204 provides an interface for outputting information for review by a user of liquid handling system 100. Output interface 1204 may further provide an interface for outputting information to drive system 1202 and/or liquid handling head 110 as understood by those skilled in the art. Controller 1200 may have one or more output interfaces that use the same or a different interface technology.

Communication interface 1206 provides an interface for receiving and transmitting data between devices using various protocols, transmission technologies, and media as known to those skilled in the art. Communication interface 1206 may support communication using various transmission media that may be wired or wireless. Illustrative wireless communication devices include antennas that receive and transmit electromagnetic radiation at various frequencies. Controller 1200 may have one or more communication interfaces that use the same or a different communication interface technology. Data and messages may be transferred between any input or output device and controller 1200 using communication interface 1206. Thus, communication interface 1206 provides an alternative interface to either or both of input interface 1202 and output interface 1204.

Controller 1200 may be linked to one or more interfaced devices. For example, controller 1200 may interface with another liquid handler or an external computing device. If connected, controller 1200 and the one or more interfaced devices may be connected directly or through a network. The network may be any type of wired and/or wireless public or private network including a cellular network, a local area network, a wide area network such as the Internet, etc. Controller 1200 may send and receive information to/from one or more of the interfaced devices. For example, controller 1200 may send results obtained for a sample for storage on one or more of the interfaced devices. As another example, controller 1200 may receive software updates from one or more of the interfaced devices and/or receive commands from one or more of the interfaced devices. The commands may control operation of one or more components of liquid handling system 100 including controller 1200. The one or more interfaced devices may include a computing device of any form factor such as a personal digital assistant, a desktop computer, a laptop computer, an integrated messaging device, a cellular telephone, a smart phone, a pager, etc. without limitation.

Computer-readable medium 1208 is an electronic holding place or storage for information so that the information can be accessed by processor 1210 as known to those skilled in the art. Computer-readable medium 1208 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., CD, DVD, . . . ), smart cards, flash memory devices, etc. Controller 1200 may have one or more computer-readable media that use the same or a different memory media technology. Controller 1200 also may have one or more drives that support the loading of a memory media such as a CD or DVD.

Processor 1210 executes instructions as known to those skilled in the art. The instructions may be carried out by a special purpose computer, logic circuits, or hardware circuits. Thus, processor 1210 may be implemented in hardware, firmware, or any combination of these methods and/or in combination with software. The term “execution” is the process of running an application or the carrying out of the operation called for by an instruction. The instructions may be written using one or more programming language, scripting language, assembly language, etc. Processor 1210 executes an instruction, meaning that it performs/controls the operations called for by that instruction. Processor 1210 operably couples with input interface 1202, with computer-readable medium 1208, with communication interface 1206, and with output interface 1204 to receive, to send, and to process information. Processor 1210 may retrieve a set of instructions from a permanent memory device and copy the instructions in an executable form to a temporary memory device that is generally some form of RAM. Controller 1200 may include a plurality of processors that use the same or a different processing technology.

Control application 1212 performs operations associated with controlling, maintaining, updating, etc. the operation of liquid handling system 100. Some or all of the operations described herein may be controlled by instructions embodied in control application 1212. The operations may be implemented using hardware, firmware, software, or any combination of these methods. With reference to the example embodiment of FIG. 12, control application 1212 is implemented in software (comprised of computer-readable and/or computer-executable instructions) stored in computer-readable medium 1208 and accessible by processor 1210 for execution of the instructions that embody the operations of control application 1212. Control application 1212 may be written using one or more programming languages, assembly languages, scripting languages, etc.

Control application 1212 may be configured to identify characteristics of rack plate 134 such as a model number, a number of the receptacles, an indicator of a geometrical arrangement of the receptacles, etc. Control application 1212 further may be configured to receive information identifying a content of the one or more receptacles, an indicator of one or more processing steps performed on the one or more receptacles, an indicator of one or more processing steps to be performed on the one or more receptacles, an indicator of where work bed 106 should be positioned on base plate 118, an indicator of one or more devices that have interacted with work bed 106, etc.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A translational support system comprising:
a bearing rod mounted between a first support bracket and a second support bracket, wherein the first support bracket and the second support bracket are mounted between a plurality of walls;
a bearing carriage mounted to translate along the bearing rod;
a base plate having a first side and a second side, wherein the bearing carriage is mounted to the first side; and
a rigid support mounted to the first side of the base plate, wherein the rigid support is positioned to support a device above the first side of the base plate.

2. The translational support system of claim 1, wherein the device is a liquid handling head.

3. The translational support system of claim 1, wherein the device is a rack removably mounted to the base plate.

4. The translational support system of claim 1, wherein a pad is mounted to the rigid support so that the device is supported by the pad.

5. The translational support system of claim 1, wherein a rigidity of the rigid support is sufficient to support a maximum design load applied to the base plate without flexing.

6. The translational support system of claim 5, wherein the bearing rod is selected to flex until contact is made with the rigid support when a transverse load is applied to the base plate.

7. A work bed comprising:
a translating plate;
a base including a base plate having a first side and a second side and a plurality of walls extending from the base plate in a first direction, wherein the base includes a slot formed through the base plate;
a bearing rod mounted between a first support bracket and a second support bracket, wherein the first support bracket and the second support bracket are mounted between the plurality of walls;
a bearing carriage mounted to translate along the bearing rod in a plane parallel to the first side of the base plate, the bearing carriage including a leg mounted to the translating plate through the slot; and
a rigid support mounted to the second side of the base plate, wherein the rigid support is positioned to support the translating plate above the second side of the base plate.

8. The work bed of claim 7, wherein the first support bracket and the second support bracket are mounted to the first side of the base plate between the plurality of walls.

9. The work bed of claim 7, wherein the first support bracket is mounted to a first wall of the plurality of walls and the second support bracket is mounted to a second wall of the plurality of walls.

10. The work bed of claim 7, wherein a rack is removably mounted to the base plate.

11. The work bed of claim 7, wherein a pad is mounted to the rigid support so that the translating plate is supported by the pad.

12. The work bed of claim 7, wherein a rigidity of the rigid support is sufficient to support a maximum design load applied to the translating plate without flexing.

13. The work bed of claim 12, wherein the bearing rod is selected to flex until contact is made with the rigid support when a transverse load is applied to the translating plate.

14. The work bed of claim 7, wherein the rigid support includes a plurality of rigid supports mounted to the second side of the base plate and positioned to support the translating plate.

15. The work bed of claim 14, wherein a pad is mounted to at least one of the plurality of rigid supports.

16. The work bed of claim 7, wherein the bearing carriage further includes a second leg mounted to the translating plate through a second slot formed through the base plate.

17. The work bed of claim 16, wherein the rigid support is positioned between the slot and the second slot.

18. A work bed comprising:
a translating plate;
a base including a base plate having a first side and a second side, wherein the base includes a slot formed through the base plate;
a bearing rod mounted between a first support bracket and a second support bracket, wherein the first support bracket and the second support bracket are mounted to the first side of the base;
a bearing carriage mounted to translate along the bearing rod in a plane parallel to the first side of the base plate, the bearing carriage including a leg mounted to the translating plate through the slot; and
a rigid support mounted to the second side of the base plate, wherein the rigid support is positioned to support the translating plate above the second side of the base plate.

19. The work bed of claim 18, wherein a rigidity of the rigid support is sufficient to support a maximum design load applied to the translating plate without flexing.

20. The work bed of claim 19, wherein the bearing rod is selected to flex until contact is made with the rigid support when a transverse load is applied to the translating plate.
